(19) United States
(12) Patent Application Publication
(10) Pub. No.: US 2021/0034541 A1
(43) Pub. Date: Feb. 4, 2021

(54) MEMORY SYSTEM, MEMORY CONTROL DEVICE, AND MEMORY CONTROL METHOD

(71) Applicant: FUJITSU LIMITED, Kawasaki-shi (JP)

(72) Inventor: Masazumi MAEDA, Yokohama (JP)

(73) Assignee: FUJITSU LIMITED, Kawasaki-shi (JP)

(21) Appl. No.: 16/942,391

(22) Filed: Jul. 29, 2020

(30) Foreign Application Priority Data
Aug. 2, 2019 (JP) 2019-143085

(51) Int. Cl. G06F 12/0895

(52) U.S. Cl. CPC G06F 12/0895; G06F 2212/601

(57) ABSTRACT

A memory system includes a memory that includes a buffer region having a plurality of buffer storage regions, each buffer storage region including a plurality of buffer memory cells, the plurality of buffer memory cells being cells storing data of 1 bit or a plurality of bits in units of the buffer storage regions, and a first storage region having a plurality of first storage regions including the plurality of first memory cells storing data of a plurality of bits; and a control circuit that changes at least one buffer storage region in which data is written to at least one first storage region, and changes at least one free first storage region into at least one buffer storage region to replace the changed at least one buffer storage region.

### CROSS-REFERENCE TO RELATED APPLICATION

This application is based upon and claims the benefit of priority of the prior Japanese Patent Application No. 2019-143085, filed on Aug. 2, 2019, the entire contents of which are incorporated herein by reference.

### FIELD

The embodiments discussed herein are related to a memory system, a memory control device, and a memory control method.

### BACKGROUND

Nonvolatile memories such as flash memories are used in various apparatuses such as servers, supercomputers, personal computers, mobile apparatuses, network apparatuses and digital apparatuses. In recent years, nonvolatile memories have been actively used in storage devices such as solid-state drives (SSDs). When compared with a hard disk that performs magnetic recording, an SSD may perform reading and writing at high speed, and has less power consumption and excellent impact resistance because there is no mechanical component. Thus, a size, a thickness, and a weight of a device may be reduced. Therefore, the SSD is employed in many devices as a storage unit system.

For example, in a flash memory, information of a plurality of bits is stored in a single memory cell, and thus the storage capacity may be increased and cost may be reduced. On the other hand, as the number of bits stored in a single memory cell is increased, the number of rewritable times, which is an index of the reliability of the flash memory, is decreased. Therefore, a technique has been proposed in which a number-of-times management table for storing the number of times of rewriting is provided, and a memory block in which the number of times of rewriting is equal to or greater than a set value is changed from multiple-value writing to two-value writing, so that deterioration in reliability is suppressed (for example, see Japanese Laid-open Patent Publication No. 2009-48680).

A method has been proposed in which, when a defect occurs in a memory block for multiple values, the memory block is used as a memory block for two values, and data that may not be stored in the memory block for two values is stored in a redundant region, and thus the memory block is effectively used (for example, see Japanese Laid-open Patent Publication No. 2018-73240). In a nonvolatile data storage device, there has been proposed a method of improving reading performance by distributing and transmitting data written in a cache memory storing two values to a main memory disposed over a plurality of dies and storing multiple values (for example, see Japanese Laid-open Patent Publication No. 2018-190483).

### SUMMARY

According to an aspect of the embodiments, a memory system includes a memory that includes a buffer region having a plurality of buffer storage regions, each buffer storage region including a plurality of buffer memory cells, the plurality of buffer memory cells being cells storing data of 1 bit or a plurality of bits in units of the buffer storage regions, and a first storage region having a plurality of first storage regions including the plurality of first memory cells storing data of a plurality of bits; and a control circuit that changes at least one buffer storage region in which data is written to at least one first storage region, and changes at least one free first storage region into at least one buffer storage region to replace the changed at least one buffer storage region.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of a storage unit system according to an embodiment;

FIG. 2 is an explanatory diagram illustrating an example of data written in a storage region of a buffer region by the controller of FIG. 1;

FIGS. 3A to 3G are explanatory diagrams illustrating an example of a write operation of the storage unit system of FIG. 1;

FIG. 4 is a block diagram illustrating an example of a storage unit system according to another embodiment;

FIG. 5 is a circuit diagram illustrating an example of a memory cell array structure of a block in a storage unit in FIG. 4;

FIG. 6 is a sequence diagram illustrating an example of a voltage applied to a control gate during a write operation on a memory cell;

FIG. 7 is an explanatory diagram illustrating an example of a threshold voltage of a memory cell;

FIG. 8 is a block diagram illustrating an example of a controller in FIG. 4;

FIG. 9 is an explanatory diagram illustrating an example of a management table in FIG. 8;

FIG. 10 is a flowchart illustrating an example of a write operation of the storage unit system in FIG. 4;

FIG. 11 is a flowchart illustrating a continuation of FIG. 10;

FIG. 12 is an explanatory diagram illustrating an example of the number of pages into which data is written in the storage unit system of FIG. 4;

FIG. 13 is a flowchart illustrating an example of background processing of the storage unit system in FIG. 4;

FIG. 14 is an explanatory diagram illustrating an example of data written in the storage unit in FIG. 4; and

FIG. 15 is an explanatory diagram illustrating an example of the number of pages into which data is written in a storage unit system according to still another embodiment.

### DESCRIPTION OF EMBODIMENTS

For example, in a nonvolatile data storage device, a cache memory that stores data received from the outside as two values has a larger number of rewritable times than a cache memory that stores data as multiple values, but has a higher rewriting frequency and thus may have a shorter lifetime than that of a main memory. Thus, for example, depending on a size of data to be written to the cache memory, there is concern that the data storage device will end its lifetime before reaching total byte written (TBW), which is an index of the lifetime of an SSD or the like.

Hereinafter, the embodiments will be described with reference to the drawings.

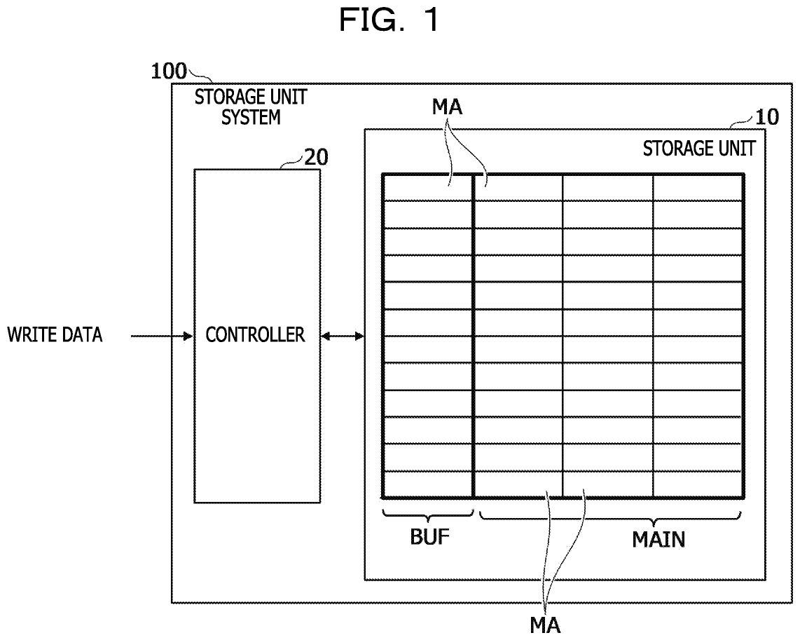

Hereinafter, a storage unit and a controller may be respectively referred to as a memory and a control circuit. FIG. 1 illustrates an example of a storage unit system according to an embodiment. A storage unit system 100 illustrated in FIG. 1 includes a storage unit 10 including a plurality of storage regions MA that store data in a nonvolatile manner, and a controller 20 that controls access to the storage unit 10. The storage unit 10 may include a plurality of nonvolatile semiconductor memory chips.

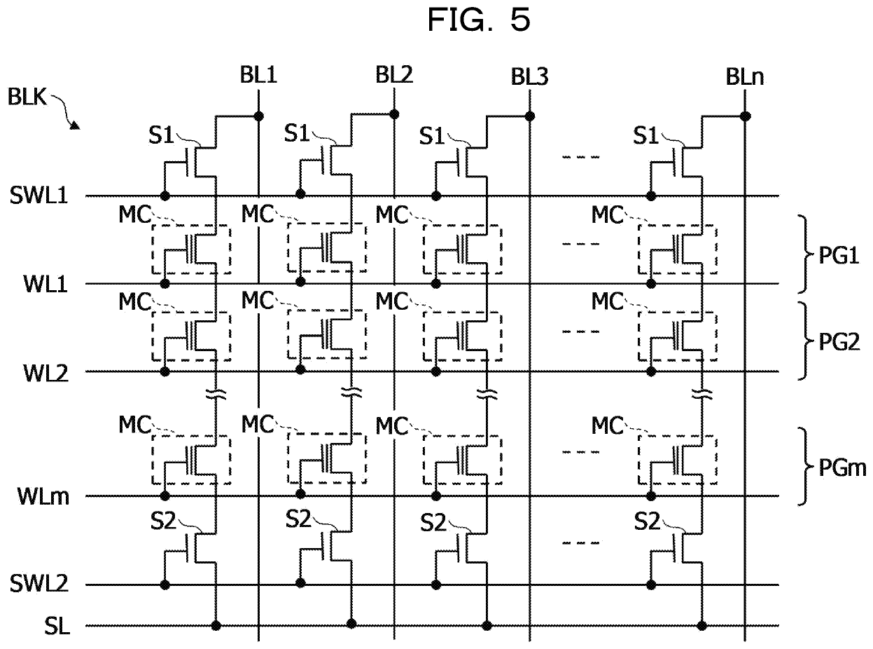

For example, each storage region MA has a memory cell array structure of a NAND flash memory and includes a plurality of nonvolatile memory cells. An example of a memory cell array structure in the storage region MA is similar to that in FIG. 5 described later. Writing of other data to the storage region MA in which data has been written is executed after the data in the storage region MA is erased. For example, data is not overwritten into the storage region MA, and data is written only once. Data is erased in the unit of a predetermined number of storage regions MA.

In an initial state of the storage unit system 100, a predetermined number of the plurality of storage regions MA are set to a buffer region BUF, and the remaining storage regions MA are set to a main storage region MAIN. The controller 20 executes control for writing write data received from the outside of the storage unit system 100 into the storage unit 10. The controller 20 is an example of a control unit or a storage unit control device.

For example, the controller 20 writes data into the memory cells of each storage region MA of the buffer region BUF in a single-bit mode in which 1-bit data is stored or in a plurality of types of multi-bit modes in which data of a plurality of bits is stored. The multi-bit mode is one of a 2-bit mode for storing 2-bit data, a 3-bit mode for storing 3-bit data, and a 4-bit mode for storing 4-bit data. The write mode (the single-bit mode, the 2-bit mode, the 3-bit mode, and the 4-bit mode) is set in the unit of the storage region MA. The controller 20 writes data into the memory cells of each storage region MA of the main storage region MAIN in the 4-bit mode.

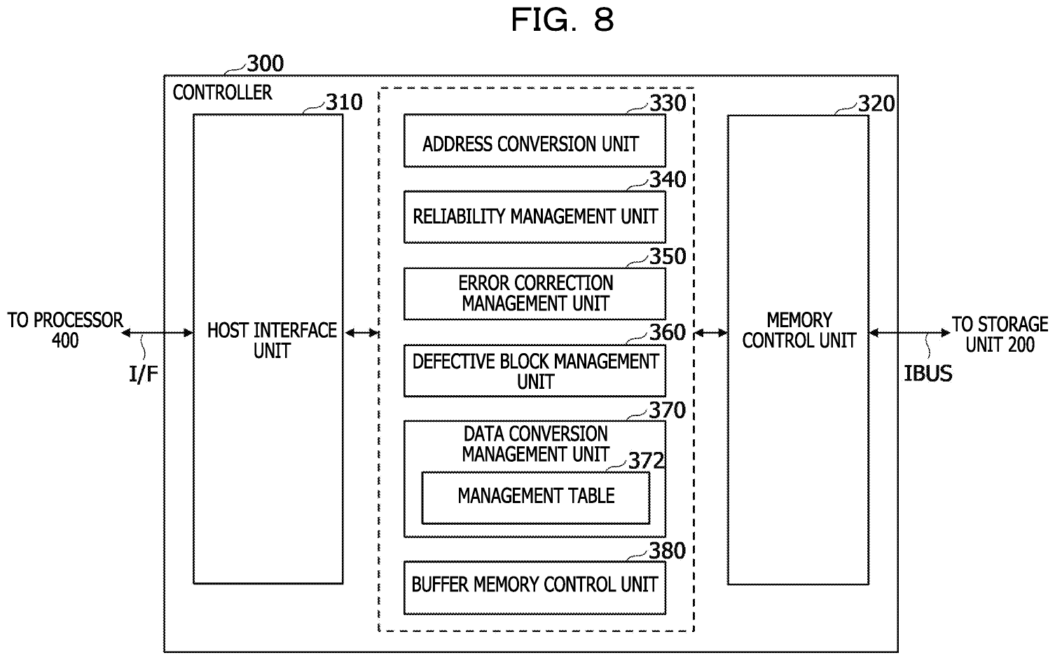

Hereinafter, a memory cell into which data is written in a single-bit mode will be referred to as a single-level cell (SLC). A memory cell into which data is written in a 2-bit mode will be referred to as a multiple-level cell (MLC). A memory cell into which data is written in a 3-bit mode will be referred to as a triple-level cell (TLC). A memory cell into which data is written in the 4-bit mode will be referred to as a quadruple-level cell (QLC). As illustrated in FIG. 8, an SLC stores 2 values, an MLC stores 4 values, a TLC stores 8 values, and a QLC stores 16 values.

The memory cell in the buffer region BUF may be set to one of two types of write modes (for example, an SLC and a QLC). When the memory cell of the buffer region BUF is set to an SLC or a TLC, the memory cell of the main storage region MAIN may be set to a TLC. The memory cell of the buffer region BUF may be set to an SLC, an MLC, or a TLC for each storage region MA, and the memory cell of the main storage region MAIN may be set to a TLC.

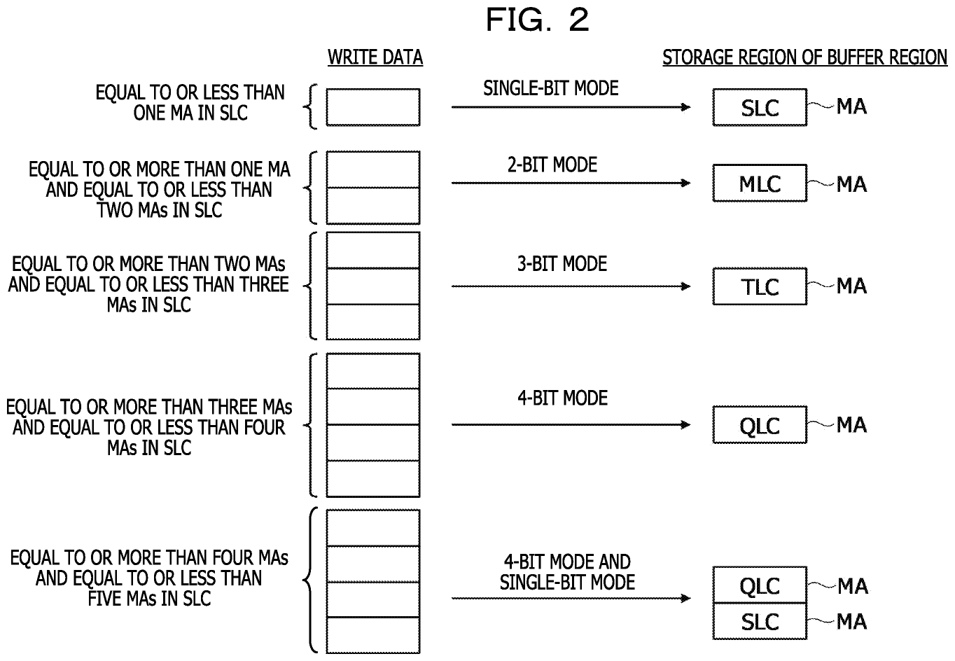

FIG. 2 illustrates an example of data written into the storage region MA of the buffer region BUF by the controller 20 in FIG. 1. A single rectangle illustrated as write data indicates a storage capacity that is storable in the single storage region MA of which the memory cell is set to an SLC. Hereinafter, the capacity of write data indicated by one rectangle will be referred to as a capacity 1.

When write data has the capacity 1, the controller 20 writes the data into the single storage region MA in the single-bit mode. For example, the memory cell of the storage region MA into which the data is written is set to an SLC. When write data has a capacity 2, the controller 20 writes the data into the single storage region MA in the 2-bit mode. For example, the memory cell of the storage region MA into which data is written is set to an MLC. When write data has a capacity 3, the controller 20 writes the data into the single storage region MA in the 3-bit mode. For example, the memory cell of the storage region MA into which data is written is set to a TLC.

When write data has a capacity 4, the controller 20 writes the data into the single storage region MA in the 4-bit mode. For example, the memory cell of the storage region MA into which data is written is set to a QLC. When write data has a capacity 5, the controller 20 writes the data into the single storage region MA in the 4-bit mode and the single storage region MA in the single-bit mode.

Even when write data has different capacities, the controller 20 writes data into each storage region MA by combining the single-bit mode, the 2-bit mode, the 3-bit mode, and the 4-bit mode with each other. Consequently, it is possible to minimize the number of storage regions MA into which data is written. It is possible to reduce the frequency of transferring data written in the storage region MA in the single-bit mode into another storage region MA in another write mode.

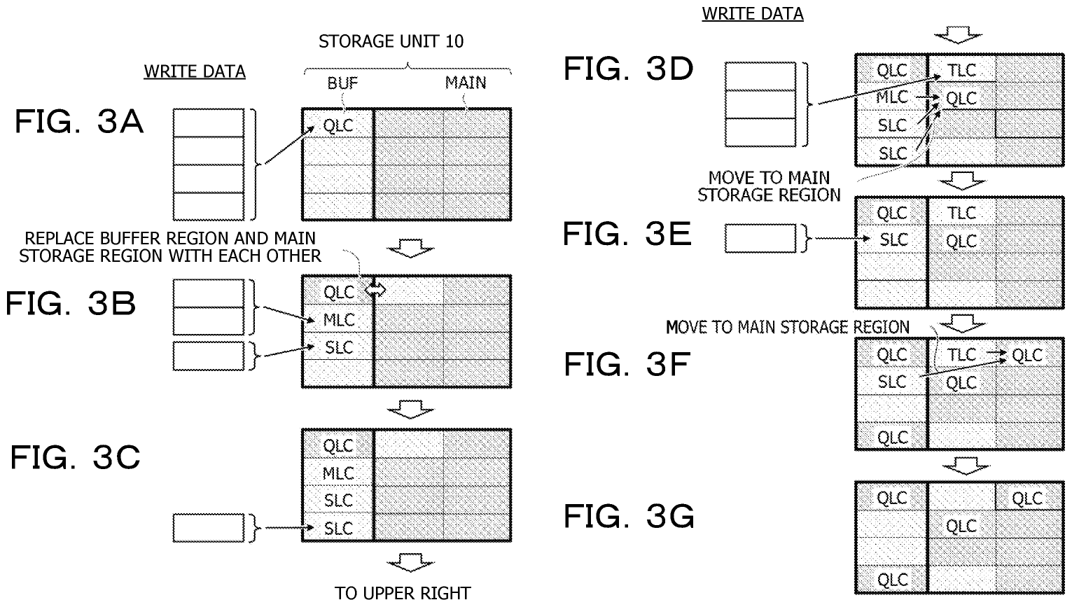

FIGS. 3A to 3G illustrate an example of a write operation of the storage unit system 100 in FIG. 1. Detailed description of the operations that are the same as those illustrated in FIG. 2 will be omitted. Also in FIGS. 3A to 3G, in the same manner as in FIG. 2, a single rectangle illustrated as write data indicates data having the capacity 1 (for example, data that is writable into the single storage region MA in the single-bit mode). In the storage unit 10, light shading indicates the buffer region BUF, and dark shading indicates the main storage region MAIN.

First, in FIG. 3A, the controller 20 writes the write data having the capacity 4 into the single storage region MA (QLC) in the 4-bit mode.

Next, in FIG. 36, the controller 20 changes the storage region MA (QLC) of the buffer region BUF in which the data having the capacity 4 is written in FIG. 3A to the main storage region MAIN. The controller 20 changes free storage regions MA of the main storage region MAIN of which the number is the same as the number of storage regions MA (QLC) of the buffer region BUF storing the data having the capacity 4, to the buffer region BUF. For example, the controller 20 replaces the storage region MA of the buffer region BUF in which the data having the capacity 4 is written with the free storage region MA of the main storage region MAIN without moving data. Here, the free storage region MA is a storage region MA in an erased state that does not store data.

Consequently, it is possible to minimize the number of storage regions MA into which data is written in the storage unit system 100 in which externally received data is written into the buffer region BUF and then moved to the main storage region MAIN. It is possible to minimize the number of times of data movement from the buffer region BUF to the main storage region MAIN. As a result, the number of times of writing data and the number of times of erasing data may be minimized, and thus the lifetime of the storage unit 10 including the buffer region BUF and the main storage region MAIN may be extended.

In FIG. 38, the controller 20 writes the write data having the capacity 2 into the single storage region MA (MLC) in the 2-bit mode, and writes the write data having the capacity 1 into the single storage region MA (SLC) in the single-bit mode. Next, in FIG. 3C, the controller 20 writes the write data having the capacity 1 into the single storage region MA (SLC) in the single-bit mode.

Next, in FIG. 3D, the controller 20 writes the data stored in the three storage regions MA of the buffer region BUF in which the capacity 2, the capacity 1, and the capacity 1 are written in FIGS. 3B and 3C into the single free storage region MA of the main storage region MAIN in the 4-bit mode. For example, the controller 20 moves the data to the main storage region MAIN when the capacity may be made 4 by combining the data other than the capacity 4 stored in the buffer region BUF.

As a result, it is possible to move the data written in the storage regions MA of the buffer region BUF in the plurality of write modes to the storage regions MA of the minimum number of the main storage region MAIN, and thus to suppress a reduction in the use efficiency of the main storage region MAIN. The controller 20 writes the write data having the capacity 3 into the single storage region MA (TLC) in the 3-bit mode.

Next, in FIG. 3E, the controller 20 moves the data to the main storage region MAIN, and thus erases data in the storage region MA storing invalid data in the buffer region BUF. After the data is moved to the main storage region MAIN, the data stored in the storage region MA of the buffer region BUF is erased, so that a reduction in the number of storage regions MA of the buffer region BUF may be suppressed. As described above, data is erased in the unit of a predetermined number of storage regions MA. Thereafter, the controller 20 writes the write data having the capacity 1 into the single storage region MA (SLC) in the single-bit mode.

Next, in FIG. 3F, the controller 20 executes the same operation as that in FIG. 3D. For example, the controller 20 writes the data stored in the two storage regions MA of the buffer region BUF in which the capacity 3 and the capacity 1 are written in FIGS. 3D and 3E into a single free storage region MA of the main storage region MAIN in the 4-bit mode.

Next, in FIG. 3G, the controller 20 moves the data to the main storage region MAIN, and thus erases the data in the storage region MA storing the invalid data in the buffer region BUF. Consequently, the number of storage regions MA of the buffer region BUF and the number of storage regions MA of the main storage region MAIN may be maintained at the same number as in the initial state in FIG. 3A. For example, it is possible to suppress a reduction in the number of storage regions MA of the buffer region BUF into which data received from the outside is written, and thus to suppress deterioration in the efficiency of writing data into the buffer region BUF.

As described above, in this embodiment, in the storage unit system 100 in which data received from the outside is written into the main storage region MAIN via the buffer region BUF, the controller 20 writes data into the storage region MA of the buffer region BUF in one of the plurality of write modes. Thus, the number of storage regions MA of the buffer region BUF into which data is written may be minimized. Since the controller 20 changes the allocation of the storage region MA of the buffer region BUF into which the data having the capacity 4 is written to the main storage region MAIN, the number of times of physical data movement from the buffer region BUF to the main storage region MAIN may be minimized. As a result, the number of times of writing data and the number of times of erasing data may be minimized, and thus the lifetime of the storage unit 10 including the buffer region BUF and the main storage region MAIN may be extended.

The data written in the storage regions MA of the buffer region BUF in the plurality of write modes may be moved to the storage regions MA of the minimum number of the main storage region MAIN, and thus it is possible to suppress deterioration in the use efficiency of the main storage region MAIN. The data stored in the storage region MA of the buffer region BUF is erased after the data is moved, and thus it is possible to suppress a reduction in the number of free storage regions MA of the buffer region BUF.

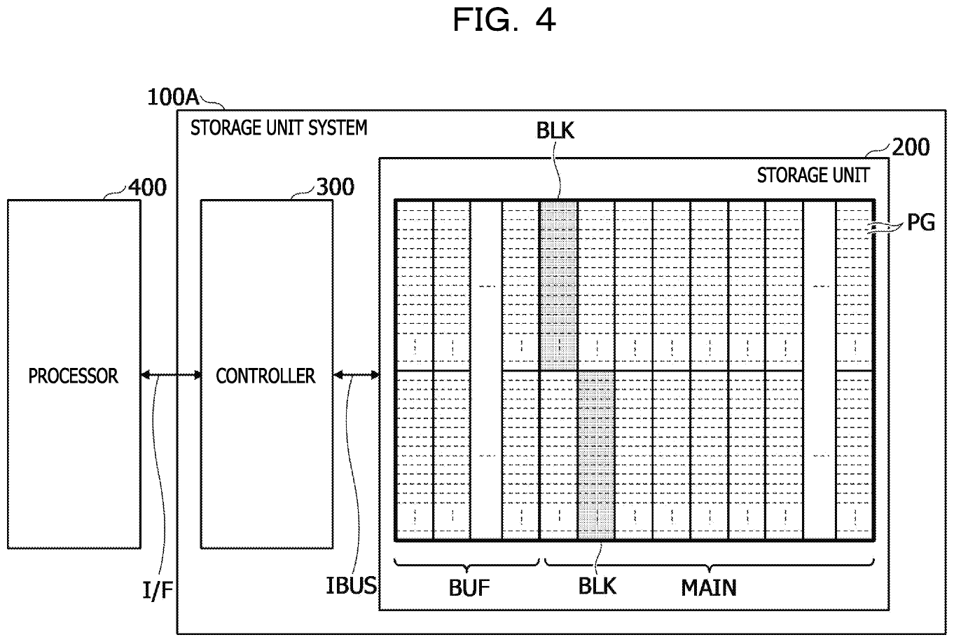

FIG. 4 illustrates an example of a storage unit system in another embodiment. A storage unit system 100A illustrated in FIG. 4 includes a storage unit 200 including a plurality of blocks BLK that store data in a nonvolatile manner, and a controller 300 that controls access to the storage unit 200.

For example, each block BLK has a memory cell array structure of a NAND flash memory and includes a plurality of pages PG each including a plurality of nonvolatile memory cells. The page PG is an example of a storage region. In FIG. 4, in order to dearly illustrate a range of the blocks BLK, some of the blocks BLK are shaded. An example of the memory cell array structure in the block BLK is illustrated in FIG. 5. The storage unit 200 may include a plurality of nonvolatile semiconductor memory chips. In this case, a plurality of blocks BLK are included in each nonvolatile semiconductor memory chip.

In an initial state of the storage unit system 100A, a predetermined number of the plurality of blocks BLK are set to the buffer region BUF, and the remaining blocks of the plurality of BLK are set to the main storage region MAIN. For example, in the initial state, the number of blocks BLK set to the main storage region MAIN is larger than the number of blocks set to the buffer region BUF. The storage unit 200 may include a redundant block used instead of the defective block BLK. In this case, the redundant block is disposed in one or both of the buffer region BUF and the main storage region MAIN. The size of the redundant block may be smaller than the size of the block BLK.

The controller 300 accesses the storage unit 200 via an internal bus IBUS based on an instruction from a processor 400 such as a central processing unit (CPU) coupled to the storage unit system 100A. Then, the controller 300 executes a write operation of writing data into the storage unit, a read operation of reading data from the storage unit, and an erase operation of erasing data stored in the storage unit 10. The write operation and the erase operation respectively include a write verify operation and an erase verify operation for checking a threshold value of the memory cell MC.

For example, the controller 300 and the processor 400 are coupled via an interface I/F such as Serial AT Attachment (SATA), Peripheral Component Interconnect Express (PCIe), or Non-Volatile Memory Express (NVMe). For example, the storage unit system 100A illustrated in FIG. 1 is applied to a solid-state drive (SSD), but may be applied to a device other than the SSD.

FIG. 5 illustrates an example of the memory cell array structure of the block BLK in the storage unit 200 in FIG. 4. Each block BLK includes a plurality of memory cells MC arranged in a matrix, and n select transistors S1 and n select transistors S2 arranged in a horizontal direction in FIG. 5. Each block BLK includes m word lines WL (WL1, WL2, . . . , and WLm), two select word lines SWL (SWL1 and SWL2), a source line SL, and n bit lines BL (B1, BL2, B3, . . . , and BLn). Each memory cell MC is a nonvolatile memory cell having a control gate and a floating gate.

The control gates of the n memory cells MC arranged in the horizontal direction in FIG. 5 are coupled to a common word line WL. Gates of the n select transistors S1 arranged in the horizontal direction in FIG. 5 are coupled to the common select word line SWL1, and gates of the n select transistors S2 arranged in the horizontal direction in FIG. 5 are coupled to the common select word line SWL2. Hereinafter, in the memory cell MC and the select transistors S1 and S2, the bit line BL side will be referred to as a drain, and the source line SL side will be referred to as a source.

The select transistor S1, the m memory cells MC (cell transistors), and the select transistor S2 arranged in a vertical direction in FIG. 5 are coupled in series to each other. The drain of the select transistor S1 is coupled to the bit line BL, and the source of the select transistor S2 is coupled to the source line SL which is wired in common for each block BLK. The m memory cells MC coupled in series function as a memory cell column, and the n memory cells MC coupled to each word line WL function as pages PG (PG1, PG2, . . . , and PGm).

Data is simultaneously written into the memory cells MC of each page PG, and data is simultaneously read from the memory cells MC of each page PG. For example, each block BLK includes 64 word lines WL and 2048 bit lines BL, but the number of word lines WL and the number of bit lines BL may be 2 or greater.

As in the embodiment described with reference to FIGS. 1 to 3G, each memory cell MC of the buffer region BUF may store any of 1-bit (SLC), 2-bit (MLC), 3-bit (TLC), or 4-bit (QLC) data. Each memory cell MC of the main storage region MAIN may store 4-bit (QLC) data. Hereinafter, an SLC, an MLC, a TLC, and a QLC will also be referred to as memory cell types. A write mode (the single-bit mode, the 2-bit mode, the 3-bit mode, or the 4-bit mode) for writing data into the memory cell MC is set in the unit of the page PG.

For example, when 2048 memory cells MC are included in one page PG, the storage capacity per page is 2k bits in an SLC, 4k bits in an MLC, 6k bits in a TLC, and 8k bits in a QLC. As in the above-described embodiment, the storage capacity of the page PG set to an SLC is set to the capacity 1, the storage capacity of the page PG set to an MLC is set to the capacity 2, the storage capacity of the page PG set to a TLC is set to the capacity 3, and the storage capacity of the page PG set to a QLC is set to the capacity 4. For example, data written into 12 pages PG in the single-bit mode is written into 6 pages PG in the 2-bit mode, written into 4 pages PG in the 3-bit mode, and written into 3 pages PG in the 4-bit mode.

The reliability of the memory cell MC is higher in the order of an SLC, an MLC, a TLC, and a QLC. For example, the number of times in which data is rewritable is 100,000 for an SLC, 10,000 for an MLC, 3,000 for a TLC, and 1000 for a QLC, but is not limited thereto. The reliability of the memory cell MC is reduced when the gate insulating film is degraded by data rewriting and thus the number of rewritable times is reduced.

In the write operation, the word line WL of the page PG including the memory cell MC into which data is written is set to a high voltage, and the word lines WL of the other pages PG are set to a positive voltage for turning on the cell transistors. A substrate of the memory cell MC and the source line SL are set to, for example, a ground voltage.

In each memory cell column, the bit line BL coupled to the memory cell MC into which data is written is set to the ground voltage, and the bit line BL coupled to the memory cell MC into which data is not written is set to a positive voltage such as the power supply voltage. The select word line SWL1 is set to a positive voltage such as the power supply voltage. The select word line SWL2 is set to the ground voltage.

Thus, the select transistor S1 coupled to the bit line BL with the ground voltage is turned on, and a channel of the cell transistor of the memory cell column including the memory cell MC into which data is written is set to the ground voltage of the bit line BL Since the select transistor S1 coupled to the bit line BL with the positive voltage is turned off, the ground voltage is not transmitted to the memory cell column into which data is not written.

Consequently, electrons are injected into the floating gate of the memory cell MC (cell transistor) into which data is written due to the tunnel effect based on a voltage difference between the control gate (word line WL) and a channel region of the cell transistor. When the electrons are injected into the floating gate, a threshold voltage of the cell transistor is increased, and thus a write operation is executed.

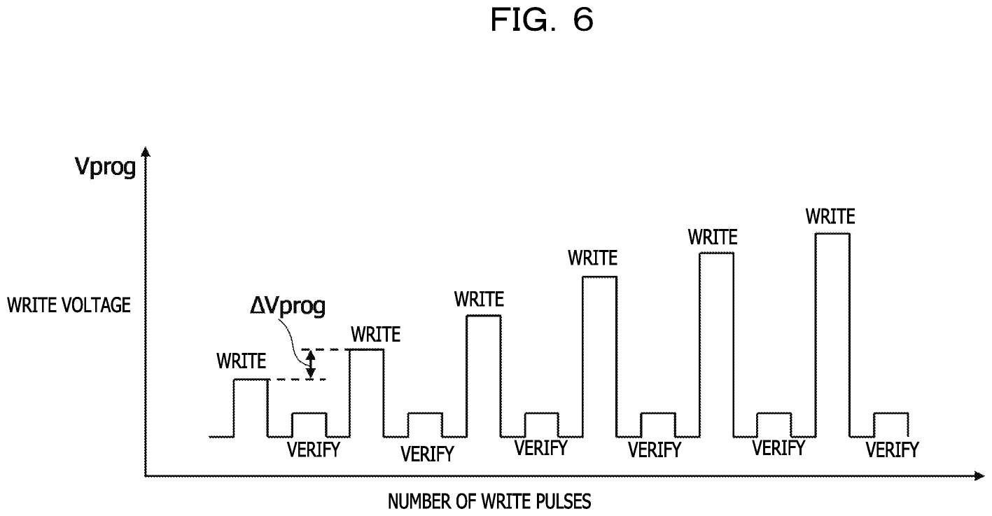

After the write operation, a write verify operation for checking that the threshold voltage of the memory cell MC exceeds a predetermined value is executed, and when the threshold voltage is equal to or less than the predetermined value, an additional write operation is executed. An example of a sequence of the write operation will be described with reference to FIG. 6.

In the erase operation, the substrate is set to a high voltage, and all the word lines WL of the block BLK from which data is to be erased are set to the ground voltage. As a result, electrons in the floating gate are extracted to the substrate side, and the threshold voltage of the memory cell MC is reduced, so that the erase operation is executed. In order to execute the erase operation in the unit of the block BLK, the substrate is electrically separated for each block BLK. After the erase operation, an erase verify operation for checking the threshold voltage of the memory cell MC is executed. For example, the memory cell MC in an erased state is in a depletion state in which the source and the drain are electrically coupled to each other even when the threshold voltage is a negative value and the word line WL is set to the ground voltage (0 V).

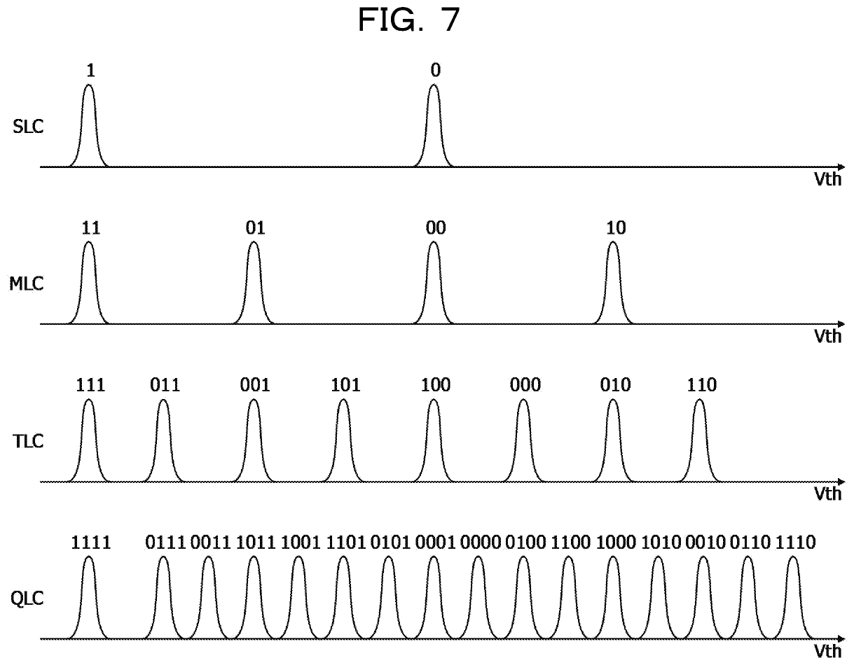

In an SLC write operation, one type of threshold voltage is set. In an MLC write operation, three types of threshold voltages are set. In a TLC write operation, seven types of threshold voltages are set. In a QLC write operation, fifteen types of threshold voltages are set. An example of the threshold voltage of the memory cell MC is illustrated in FIG. 7.

In the write operation and the erase operation, since electrons pass through the gate insulating film between the floating gate and the substrate, the gate insulating film deteriorates each time the write operation and the erase operation are executed.

FIG. 6 illustrates an example of a voltage applied to the control gate during the write operation on the memory cell MC. The write operation is executed until a threshold voltage of the cell transistor exceeds a predetermined value corresponding to a logical value of write data while sequentially increasing a write voltage Vprog (write voltage pulse) applied to the control gate.

The threshold voltage of the cell transistor is determined based on a verify operation executed after application of the write voltage Vprog. The write voltage Vprog is increased by a predetermined increment ΔVprog for each write operation. The increment ΔVprog after the start of the write operation may be set to be larger than the increment ΔVprog in the latter half of the write operation, or may be changed according to a logical value of the write data. An initial value of the write voltage Vprog and the increment ΔVprog may differ depending on the memory cell type (an SLC, an MLC, a TLC, and a QLC).

As described above, by executing the write operation with a plurality of write pulses while gradually increasing the write voltage Vprog, it is possible to set a threshold voltage with high accuracy and to store multiple values in the single memory cell MC. On the other hand, as the number of write pulses increases, the write operation time becomes longer, and the gate insulating film is more likely to deteriorate. For example, as the number of bits that is storable in the memory cell MC increases, the number of write pulses increases, so that the number of times in which data is rewritable decreases. As a result, the reliability of the memory cell MC is reduced. As the number of bits that is storable in the memory cell MC increases, the write operation time increases. For example, as the number of bits that is storable in the memory cell MC increases, the write speed decreases.

FIG. 7 illustrates an example of the threshold voltage Vth of the memory cell MC. FIG. 7 illustrates examples of distributions of the threshold voltage Vth set through the write operation, and the threshold voltage Vth increases toward the right side of FIG. 7. The threshold voltage Vth of an SLC is set to either of the threshold voltage Vth (logical value of 1) in an erased state and one threshold voltage Vth (logical value of 0) in a written state. The threshold voltage Vth of an MLC is set to either of the threshold voltage Vth (logical value of 11) in an erased state and three threshold voltages Vth (logical values of 01, 00, and 10) in a written state.

The threshold voltage Vth of a TLC is set to either of the threshold voltage Vth (logical value of 111) in an erased state and seven threshold voltages Vth in a written state (logical values of 011, 001, 101, 100, 000, 010, and 110). The threshold voltage Vth of a QLC is set to either of the threshold voltage Vth (logical value of 1111) in an erased state and fifteen threshold voltages Vth in a written state (logical values of 0111, 1001, . . . , and 1110).

The erased state (all logical values are 1) is a state in which electrons are not accumulated in the floating gate, and the written state (at least 1 bit of the logical value is 0) is a state in which a predetermined amount of electrons are injected into the floating gate. In an MLC, a TLC, and a QLC, since the memory cell MC in a written state of a certain logical value may not be rewritten to another logical value, the write operation is executed after the erase operation.

For example, when the threshold voltage Vth in the erased state is set to a negative value and 0 V is applied to the control gate, a channel is formed in the cell transistor (for example, the memory cell MC), and the source and the drain are electrically coupled to each other. In the read operation, the word line WL coupled to the memory cell MC to be read (hereinafter, referred to as a read memory cell MC) is set to a select level, and remaining word lines WL are set to a non-select level (a low level such as the ground voltage). The select word lines SWL1 and SWL2 are set to the select level, the bit line BL is set to a predetermined positive voltage, and the source line SL is set to the ground voltage.

For example, in the read operation on an SLC, the word line WL coupled to the read memory cell MC is set to a positive voltage corresponding to the threshold voltage Vth between the logical value of 1 and the logical value of 0, and the select word lines SWL1 and SWL2 are set to the power supply voltage or the like. When the read memory cell MC stores the logical value of 1 (low Vth), a channel is formed in the read memory cell MC, a current flows from the bit line BL to the source line SL due to the electrical coupling between the source and the drain, and thus a voltage of the bit line BL decreases.

When the read memory cell MC stores the logical value of 0 (high Vth), a channel is not formed in the read memory cell MC, and the source and the drain are not electrically coupled to each other, so that a current does not flow from the bit line BL to the source line SL, and thus a voltage of the bit line BL does not decrease. Then, in the storage unit 200 in FIG. 4, a sense amplifier (not illustrated) compares a voltage of the bit line SL with a reference voltage, and thus a logical value stored in the memory cell MC is read.

In the read operation on an MLC, a TLC, and a QLC, a select level (positive voltage) for the word line WL coupled to the read memory cell MC is sequentially changed, and a voltage of the bit line BL is compared with the reference voltage each time, so that a logical value stored in the memory cell MC is read.

In FIG. 7, a difference between threshold voltages Vth corresponding to adjacent logical values decreases as the number of bits that is storable in the memory cell MC increases. For example, when electrons are likely to escape from the floating gate due to deterioration in the gate insulating film of the memory cell MC, the threshold voltage Vth may gradually decrease. As a result, when distributions of two adjacent threshold voltages Vth overlap each other, an accurate logical value may not be read, and a defect occurs. Therefore, as described above, as the number of bits that is storable in the memory cell MC increases, the reliability is likely to decrease.

FIG. 8 illustrates an example of the controller 300 in FIG. 4. The controller 300 includes a host interface unit 310, a memory control unit 320, an address conversion unit 330, a reliability management unit 340, an error correction management unit 350, a defective block management unit 360, a data conversion management unit 370, and a buffer memory control unit 380.

The host interface unit 310 transmits and receives control signals, data, and the like to and from the processor 400 via the interface I/F. The memory control unit 320 has a function of controlling access to the storage unit 200, and transmits and receives control signals, data, and the like to and from the storage unit 200 via the internal bus IBUS. Here, the access to the storage unit 200 includes a write operation, a read operation, an erase operation, and various verify operations.

The address conversion unit 330 converts a logical address received from the processor 400 via the host interface unit 310 into a physical address allocated to the memory cell MC of the storage unit 200, and outputs the converted physical address to the memory control unit 320. The reliability management unit 340 manages the number of times of erasing data (the number of times of rewriting) for each block BLK of the storage unit 200. The reliability management unit 340 performs wear-leveling control or the like for averaging (distributing) the number of times of writing data into each block BLK of the storage unit 200 based on, for example, a history of access to the storage unit 200.

The error correction management unit 350 detects an error of data read from the storage unit 200, and corrects the error in a case where the error is correctable. The error correction management unit 350 manages an address at which an error is detected, the type of the error, the number of times of detecting the error, and the like. A content of an error correction process is not particularly limited, and a known error detection/correction method may be applied.

The defective block management unit 360 performs a process of detecting a defective block BLK in the storage unit 200 and manages information indicating the detected defective block BLK. For example, the defective block management unit 360 stores, for each block BLK, defective block information indicating whether or not the block BLK is defective. The defective block management unit 360 detects a defective block BLK based on, for example, the number of times of erasing each block BLK managed by the reliability management unit 340, and error information such as the type of error and the number of times of error detection managed by the error correction management unit 350.

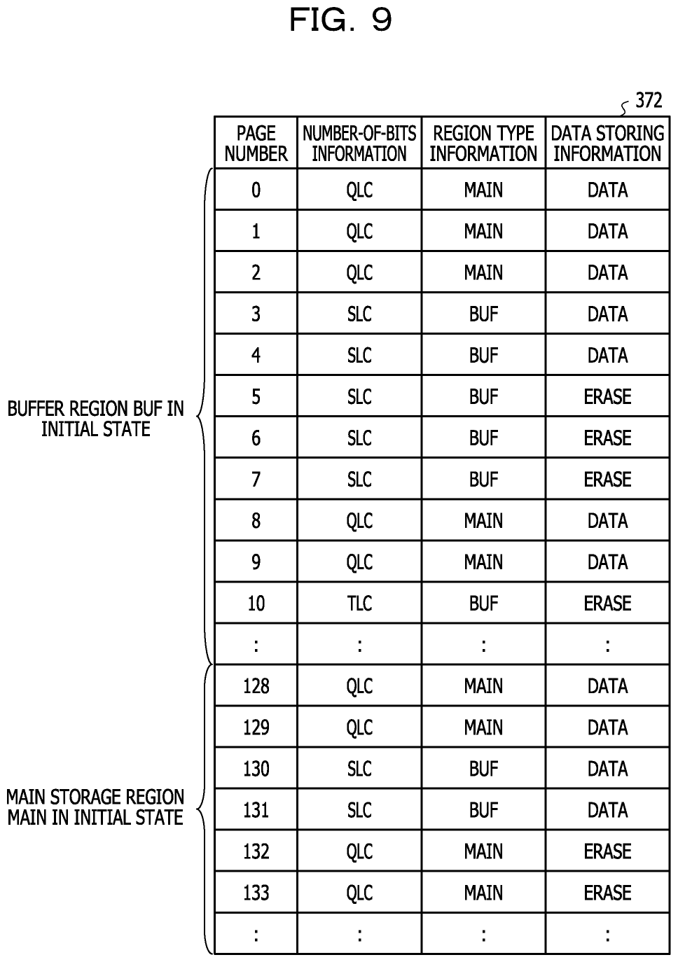

The data conversion management unit 370 includes a management table 372. The data conversion management unit 370 manages writing of data for each page PG of the storage unit 200 based on information stored in the management table 372. An example of the management table 372 is illustrated in FIG. 9.

The buffer memory control unit 380 controls an operation of a buffer memory (not illustrated) that stores write data to be written into the memory cells MC of the storage unit 200 and read data read from the memory cells. For example, the buffer memory is a general purpose memory such as a dynamic random-access memory (DRAM) or a static random-access memory (SRAM), and is coupled to the host interface unit 310.

FIG. 9 illustrates an example of the management table 372 of FIG. 8. In FIG. 9, in an initial state, the buffer region BUF is assumed to have 8 blocks BLK each including 16 pages PG. For example, a total number of pages PG in the buffer region BUF is 128.

The management table 372 has regions for storing a page number, number-of-bits information, region type information, and data storing information for each page PG. For example, page numbers are allocated in order from the buffer region BUF in the initial state. The management table 372 may not have the region for storing the page number. In this case, a row number (entry number) of the management table 372 indicates a page number.

The number-of-bits information stores information indicating any of an SLC, an MLC, a TLC, and a QLC in order to identify in which write mode data of each page PG is written. The region type information stores information indicating whether the page PG is used as the main storage region MAIN or the buffer region BUF. The data storing information stores information indicating data when valid data is written, and stores information indicating erasure when data is not written and is in an erased state.

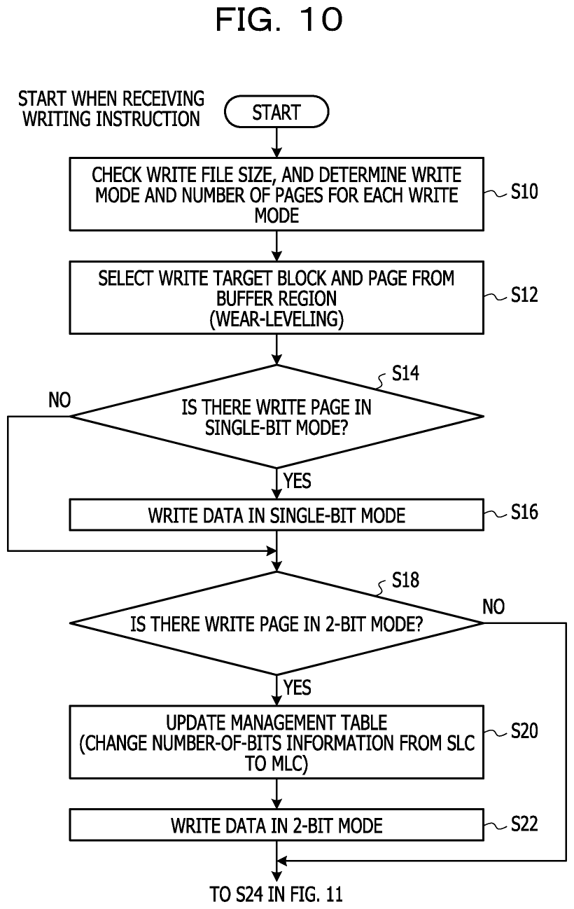

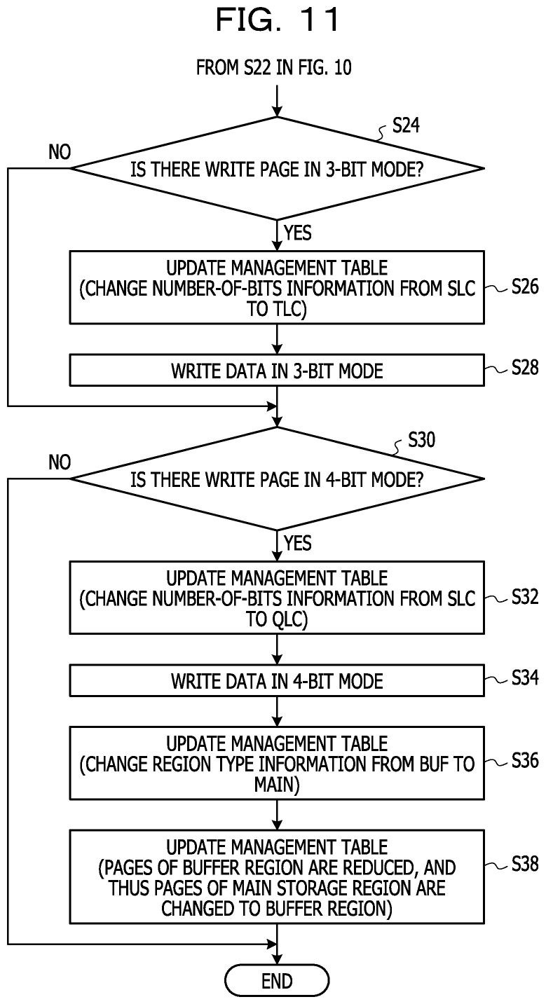

FIGS. 10 and 11 illustrate an example of a write operation of the storage unit system 100A in FIG. 4. A flow illustrated in FIGS. 10 and 11 is started when the controller 300 receives a data writing instruction from the processor 400. In FIGS. 10 and 11, an outline of an operation of writing write data into the buffer region BUF is the same as the operation described in FIGS. 3A to 3G.

First, in step S10, the controller 300 checks a file size of data to be written to the storage unit 200 based on a write instruction from the processor 400, and determines a data write mode and the number of pages PG into which data is written for each write mode.

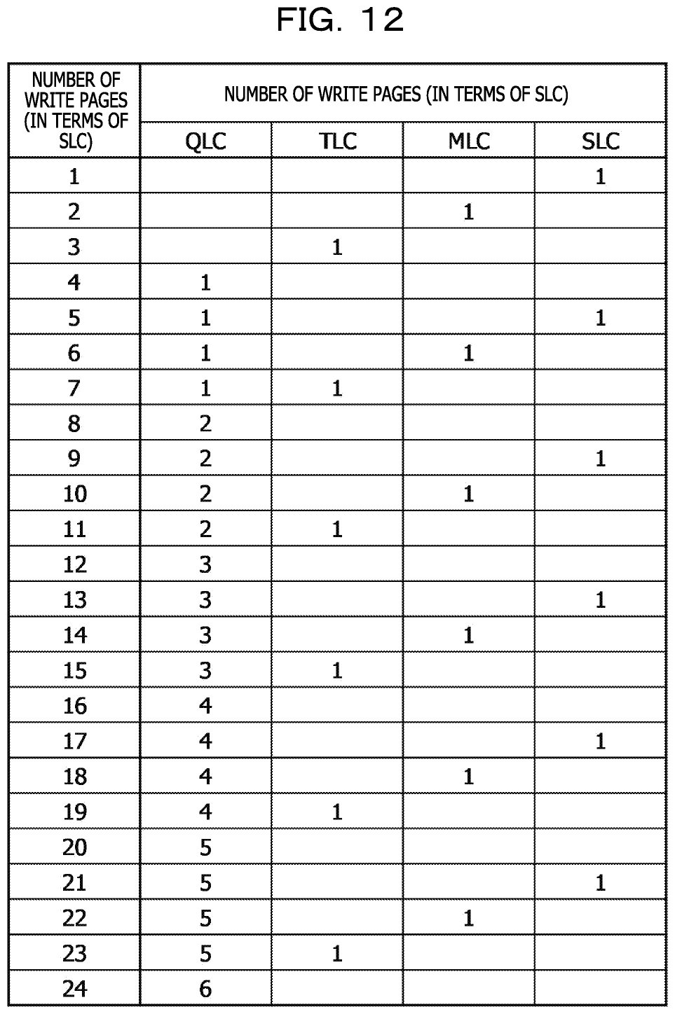

For example, first, the controller 300 calculates the number of pages when data is written in the single-bit mode. The controller 300 determines a write mode and the number of pages for each write mode based on the calculated number of pages. An example of calculating the number of pages into which data is written will be described with reference to FIG. 12.

Next, in step S12, the controller 300 selects a block BLK and a page PG into which data is to be written from the buffer region BUF for each write mode. In this case, the controller 300 causes the reliability management unit 340 to perform a wear-leveling process, and selects the block BLK such that the number of times of writing on the block BLK is averaged in the buffer region BUF. For example, the data conversion management unit 370 stores the number-of-bits information in an entry corresponding to the page PG into which the data is written in the management table 372.

Next, in step S14, the controller 300 executes step S16 when there is a page PG into which data is to be written in the single-bit mode, and executes step S18 when there is no page PG into which data is to be written in the single-bit mode. In step S16, the controller 300 writes data in the single-bit mode into the write target page PG (buffer region BUF) in the single-bit mode, selected in step S12. The data conversion management unit 370 of the controller 300 sets, in the management table 372, the data storing information of the page PG in which the data is written, to “data” indicating that the data is written, and causes the operation to proceed to step S18.

In step S18, the controller 300 executes step S20 when there is a page PG into which data is to be written in the 2-bit mode, and executes step S24 of FIG. 11 when there is no page PG into which data is to be written in the 2-bit mode. In step S20, the data conversion management unit 370 of the controller 300 updates the management table 372 by changing the number-of-bits information of the write target page PG from an SLC to an MLC in the management table 372.

Next, in step S22, the controller 300 writes data in the 2-bit mode into the write target page PG (buffer region BUF) in the 2-bit mode, selected in step S12. The data conversion management unit 370 of the controller 300 sets, in the management table 372, the data storing information of the page PG in which the data is written, to “data” indicating that the data is written. Thereafter, step S24 in FIG. 11 is executed.

In step S24, the controller 300 executes step S26 when there is a page PG into which data is to be written in the 3-bit mode, and executes step S30 when there is no page PG into which data is to be written in the 3-bit mode. In step S26, the data conversion management unit 370 of the controller 300 updates the management table 372 by changing the number-of-bits information of the write target page PG from an SLC to a TLC in the management table 372. Next, in step S28, the controller 300 writes data in the 3-bit mode into the write target page PG (buffer region BUF) in the 3-bit mode, selected in step S12. The data conversion management unit 370 of the controller 300 sets, in the management table 372, the data storing information of the page PG in which the data is written, to “data” indicating that the data is written. Thereafter, step S30 is executed.

In step S30, the controller 300 executes step S32 when there is a page PG into which data is to be written in the 4-bit mode, and finishes the write operation when there is no page PG into which data is to be written in the 4-bit mode. In step S32, the data conversion management unit 370 of the controller 300 updates the management table 372 by changing the number-of-bits information of the write target page PG from an SLC to a QLC in the management table 372. Next, in step S34, the controller 300 writes data in the 4-bit mode into the write target page PG (buffer region BUF) in the 4-bit mode, selected in step S12. The data conversion management unit 370 of the controller 300 sets, in the management table 372, the data storing information of the page PG in which the data is written, to “data” indicating that the data is written.

Next, in step S36, the data conversion management unit 370 of the controller 300 changes the region type information of the page PG in which the data is written in step S34 from the buffer region BUF to the main storage region MAIN in the management table 372. Consequently, the management table 372 is updated, and thus at least a part of the file received from the processor 400 may be stored in the page PG of the main storage region MAIN without transferring data from the buffer region BUF to the main storage region MAIN.

Next, in step S38, the controller 300 performs a process of restoring the number of pages PG of the buffer region BUF reduced by the process in step S36 to an original number. For example, the data conversion management unit 370 of the controller 300 searches the management table 372 for a page PG in which the region type information is “MAIN” and the data storing information is “erase”. The data conversion management unit 370 restores the number of pages PG of the buffer region BUF to the original number by changing the region type information of any of the pages PG found through the search to “BUF”. Then, the controller 300 finishes the write operation based on the writing instruction from the processor 400.

FIG. 12 illustrates an example of the number of pages into which data is written in the storage unit system 100A in FIG. 4. As described with reference to FIG. 10, the controller 300 calculates the number of pages when data is to be written in the single-bit mode (SLC) based on a file size of write data. When the number of pages PG into which data is to be written in the single-bit mode is four or more, the controller 300 determines that data is to be written into one page in the 4-bit mode (QLC) for each piece of data of 4 pages in the single-bit mode.

In a case where there is remaining data, and the number of pages into which the remaining data is to be written in the single-bit mode is three, the controller 300 determines that data of three pages is to be written into one page in the 3-bit mode (TLC). In a case where there is remaining data, and the number of pages into which the remaining data to be written in the single-bit mode is two, the controller 300 determines that data of two pages is to be written into one page in the 2-bit mode (MLC). In a case where there is remaining data, and the number of pages into which the remaining data to be written in the single-bit mode is one, the controller 300 determines that the remaining data is to be written into one page in the single-bit mode (SLC).

The controller 300 may divide the number of pages when data is written in the single-bit mode (SLC) by 4, and may set the quotient to the number of pages into which data is to be written in the 4-bit mode in a case where the quotient is 1 or more. Then, the controller 300 may determine that data is to be written into one page in the 3-bit mode, the 2-bit mode, or the single-bit mode according to the remainder. The controller 300 may store a list of the number of pages into which data is to be written illustrated in FIG. 12, and may determine the number of pages into which data is to be written based on the stored list.

For example, there will be the examination of the lifetime of the buffer region BUF in a case where the storage unit 200 includes 100 buffer regions BUF and the controller 300 repeatedly writes data into 21 pages PG in the single-bit mode (SLC). The number of times in which data is rewritable in an SLC is 100,000 for each page PG. It is assumed that the number of times of writing and the number of times of erasing on each page PG of the buffer region BUF are controlled to be same as each other through wear-leveling control or the like (here, erasing is executed in the unit of the block BLK).

The controller 300 writes data corresponding to the 21 pages PG in the single-bit mode into the buffer region BUF by dividing the data into five pages in the 4-bit mode (QLC) and one page in the single-bit mode (SLC). The five pages in the 4-bit mode (QLC) written in the buffer region BUF are moved to the main storage region MAIN without transferring the data by changing the allocation. Thus, the writing on five pages in a QLC is not related to the lifetime of the buffer region BUF.

Therefore, writing of data corresponding to 21 pages PG into the buffer region BUF in the single-bit mode is completed only once, and the maximum number of times of writing is 10,000,000 times shown in Expression (1).

100 pages×100,000/1 page=10,000,000 (1)

On the other hand, in a case where data is written into 21 pages of the buffer region BUF in the single-bit mode, and then data of 20 pages is moved from the buffer region BUF to the main storage region MAIN in the 4-bit mode, the maximum number of times of writing is about 476,000 as shown in Expression (2).

100 pages×100,000/21 pages=476,190 (2)

Therefore, the lifetime of the buffer region BUF is 21 times as long as that in a case where the method of the present embodiment is not used.

In the method of the present embodiment, five pages of the buffer region BUF are changed to the main storage region MAIN, and thus free five pages of the main storage region MAIN are changed to the buffer region BUF. Data in the single-bit mode (SLC) is stored in four pages of the buffer region BUF through four write operations of data corresponding to 21 pages PG. The data of four pages in the single-bit mode (SLC) is moved to the main storage region MAIN as data of one page in the 4-bit mode (QLC), and the data in the buffer region BUF that is a movement source is erased.

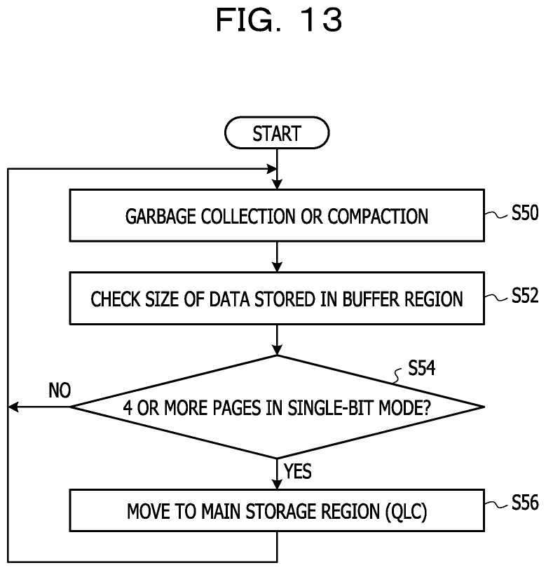

FIG. 13 illustrates an example of background processing of the storage unit system 100A in FIG. 4. An operation illustrated in FIG. 13 is repeatedly executed by the controller 300 at a predetermined frequency in a period in which the write operation, the erase operation, and the read operation are not executed. In FIG. 13, an outline of an operation of moving data from the buffer region BUF to the main storage region MAIN and erasing the data in the buffer region BUF that is a movement source is the same as the operation described in FIGS. 3A to 3G.

First, in step S50, the controller 300 performs a process of increasing the number of free pages PG by using a technique such as garbage collection or compaction. In Step S50, for example, data stored in a plurality of blocks BLK in a distributed manner is moved to one block BLK. Data in the block BLK storing only unnecessary data is erased due to the data movement. Next, in step S52, the controller 300 checks a size of data stored in the buffer region BUF.

Next, in step S54, when the size of the data stored in the buffer region BUF is equal to or more than 4 pages in the single-bit mode, the controller 300 performs step S56. When the size of the data stored in the buffer region BUF is less than 4 pages in the single-bit mode, the controller 300 returns to step S50.

In step S56, the controller 300 writes the data stored in the buffer region BUF into one page of the main storage region MAIN in the 4-bit mode (QLC) for each piece of data of four pages in the single-bit mode, and returns to step S50. As a result, the data stored in the buffer region BUF is moved to the main storage region MAIN. The data (unnecessary data) in the movement source, stored in the buffer region BUF, is erased in the unit of the block BLK in step S50 executed thereafter. The number of free pages of the buffer region BUF may be increased by erasing data in the block BLK storing unnecessary data.

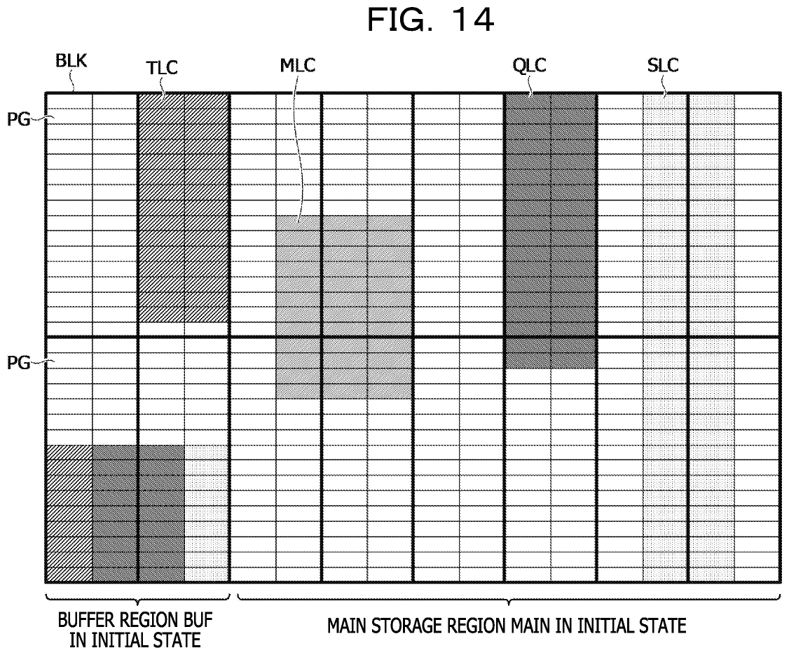

FIG. 14 illustrates an example of data written in the storage unit 200 of FIG. 4. In the example illustrated in FIG. 14, in an initial state, the buffer region BUF includes four blocks BLK, the main storage region MAIN includes 12 blocks BLK, and each block BLK includes 32 pages PG. For example, the initial state is a state in which the storage unit system 100A is started up. The number of blocks BLK in the buffer region BUF and the main storage region MAIN and the number of pages PG in the block BLK are not limited to the example illustrated in FIG. 14.

FIG. 14 illustrates an example of a state after data is repeatedly written after the storage unit system 100A is started up. In FIG. 14, a shaded page PG indicating an SLC indicates that data is written in the single-bit mode, and belongs to the buffer region BUF. A hatched page PG indicating an MLC indicates that data is written in the 2-bit mode, and belongs to the buffer region BUF. A hatched page PG indicating a TLC indicates that data is written in the 3-bit mode, and belongs to the buffer region BUF. A hatched page PG indicating a QLC indicates that data is written in the 4-bit mode, and belongs to the main storage region MAIN. A blank page PG indicates that data is erased, and belongs to either the buffer region BUF or the main storage region MAIN.

In the initial state, the controller 300 may set any page PG to the buffer region BUF or the main storage region MAIN based on an instruction from the processor 400 without allocating the page PG to the buffer region BUF or the main storage region MAIN. Since the buffer region BUF is not fixed in the initial state, the number of times of rewriting in the entire storage unit 200 may be easily leveled, and thus the lifetime of each block BLK of the storage unit 200 may be further extended.

The controller 300 may allocate the free page PG of the main storage region MAIN to the buffer region BUF when the number of times of erasing in the block BLK to which the buffer region BUF belongs exceeds a preset threshold value based on the information managed by the reliability management unit 340 in FIG. 8. In this case, the controller 300 moves data in the buffer region BUF belonging to the block BLK in which the number of times of erasing exceeds the threshold value to the newly allocated buffer region BUF. Thus, the lifetime of the buffer region BUF may be further extended.

The controller 300 may operate the defective block BLK into which data may not be normally written in the 2-bit mode, the 3-bit mode, or the 4-bit mode as a block into which data is written only in the single-bit mode. For example, the defective block BLK is detected by the defective block management unit 360 in FIG. 8. In this case, when any of the pages PG of the defective block BLK is set to the main storage region MAIN, the controller 300 may operate the defective block BLK as a block of the buffer region BUF in which writing is executed only in the single-bit mode. Consequently, it is possible to further extend the lifetime of each block BLK of the storage unit 200.

As described above, also in this embodiment, in the same manner as in the embodiment illustrated in FIGS. 1 to 3G, the number of pages PG in the buffer region BUF into which data is written may be minimized, and the number of times of data movement from the buffer region BUF to the main storage region MAIN may be minimized. As a result, the number of times of erasing data may be minimized, and the lifetime of the storage unit 200 including the buffer region BUF and the main storage region MAIN may be extended. Since data written in the buffer region BUF in the plurality of write modes is moved to the main storage region MAIN, it is possible to suppress a reduction in the use efficiency of the main storage region MAIN and to suppress a reduction in the number of free storage regions MA of the buffer region BUF.

In this embodiment, the number of pages in a case of writing data in the single-bit mode is calculated based on a size of write data received from the processor 400, and a write mode and the number of pages for each write mode are determined. Consequently, it is possible to minimize the number of pages of the buffer region BUF into which data is written even when data is written into the buffer region BUF by using a plurality of write modes.

Since the management table 372 illustrated in FIG. 9 is used, the controller 300 may easily determine the page PG of the buffer region BUF into which data is to be written, compared with a case where the management table 372 is not used. The controller 300 may easily determine the page PG of the main storage region MAIN to which data is moved from the buffer region BUF.

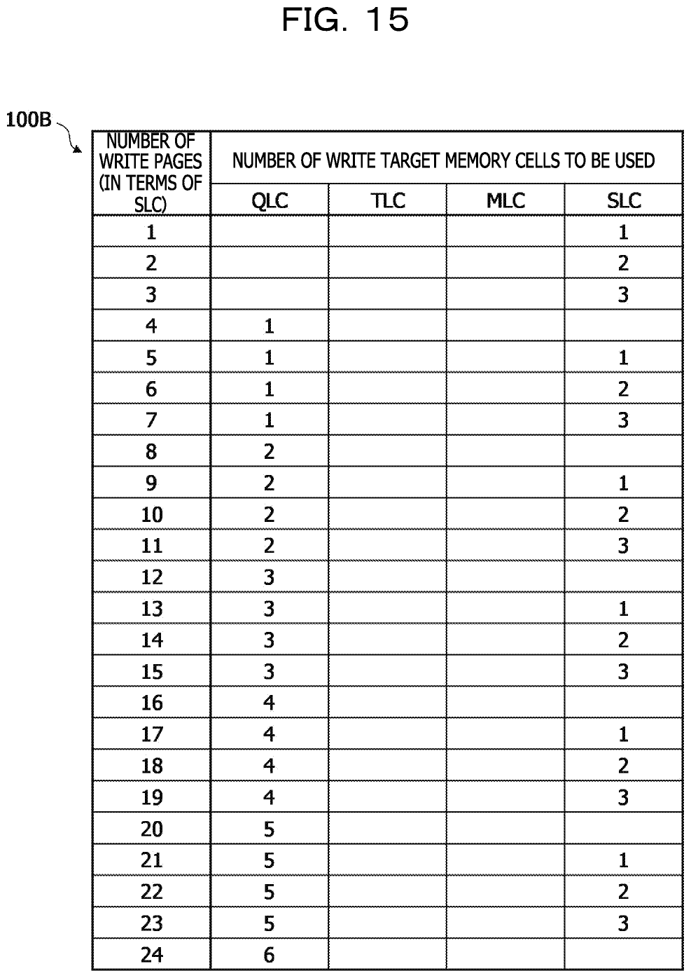

FIG. 15 illustrates an example of the number of pages into which data is written in a storage unit system according to still another embodiment. Detailed description of the components similar to or the same as those illustrated in FIGS. 4 to 14 will not be repeated. The storage unit system determining the number of pages into which data is to be written, illustrated in FIG. 15, has the same configuration as that of the storage unit system 100A illustrated in FIG. 4, and includes a controller 300, and a storage unit 200 of which access is controlled by the controller 300. Hereinafter, the storage unit system of this embodiment will be referred to as a storage unit system 100B.

A memory cell array structure of the storage unit system 100B is similar to that in FIG. 5, and a configuration of the controller 300 of the storage unit system 100B is similar to that in FIGS. 8 and 9. The storage unit system 100B executes a write operation based on a writing instruction received from the processor 400 in the same manner as in FIGS. 10 and 11. However, in this embodiment, in step S10 in FIG. 10, the controller 300 determines the type of the memory cell MC into which data is to be written to be either an SLC or a QLC, and does not select an MLC or a TLC. For example, there are two types of write modes.

For example, when the number of write pages in terms of SLC is four or more, the controller 300 determines that data is to be written into one page in a QLC for each piece of data of four pages in terms of SLC. The controller 300 determines that remaining data is to be written in an SLC by the number of write pages in terms of SLC.

In this embodiment, since the number of write modes is small, the process in step S10 in FIG. 10 may be simplified, and steps S18 to S28 in FIGS. 10 and 11 may be omitted.

The controller 300 may divide the number of pages calculated in terms of SLC by 4, set the quotient to the number of pages into which data is to be written in a QLC, and set the remainder to the number of pages into which data is to be written in an SLC. The controller 300 may store a list of the number of write pages illustrated in FIG. 15 and determine the number of pages into which data is to be written for each of a QLC and an SLC based on the stored list.

Thus, also in the embodiment illustrated in FIG. 15, the same effect as that of the embodiments illustrated in FIGS. 1 to 14 may be achieved. In this embodiment, since the type of memory cell MC into which data is written is selected from two types such as an SLC and a QLC, a write operation process may be simplified compared with that in FIGS. 10 and 11.

Features and advantages of the embodiments will be apparent from the foregoing detailed description. The scope of claims is intended to cover the features and advantages of the embodiments as described above without departing from the spirit and scope of the claims. Any person skilled in the art may readily conceive of any improvements and changes. Accordingly, there is no intention to limit the scope of the inventive embodiments to those described above, and it is possible to rely on appropriate modifications and equivalents included in the scope disclosed in the embodiments.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A memory system, comprising:
a memory that includes
a buffer region having a plurality of buffer storage regions, each buffer storage region including a plurality of buffer memory cells, the plurality of buffer memory cells being cells storing data of 1 bit or a plurality of bits in units of the buffer storage regions, and
a first storage region having a plurality of first storage regions including the plurality of first memory cells storing data of a plurality of bits; and
a control circuit that
changes at least one buffer storage region in which data is written to at least one first storage region, and
changes at least one free first storage region into at least one buffer storage region to replace the changed at least one buffer storage region.

2. The memory system according to claim 1, wherein
a number of the changed at least one buffer storage region and a number of the changed at least one free first storage region is the same when data of a plurality of bits is written in the buffer memory cells of the at least one changed buffer storage region.

3. The memory system according to claim 1,
wherein the control circuit also
writes data into the buffer memory cells and the first memory cells in one of a single-bit mode in which 1-bit data is stored and a plurality of multi-bit modes in which the number of bits of storing data differs for each of the buffer storage regions such that a number of the buffer storage regions into which data is to be written is minimized.

4. The memory system according to claim 1,
wherein control circuit
when changing the at least one buffer storage region to at least one first storage region, changes the at least one buffer storage region to the at least one first storage region such that data is written in a maximum multi-bit mode in which the number of bits of storing data is largest among the plurality of types of multi-bit modes, and
changes the at least one free first storage region to the at least one buffer storage region in a same number as the number of storage regions required for the data written in the maximum multi-bit mode to the buffer memory cells.

5. The memory system according to claim 3,
wherein the control circuit moves data from a plurality of buffer storage regions to one of the first storage regions when data written in the plurality of buffer storage regions is in a mode other than the maximum multi-bit mode.

6. The memory system according to claim 5,
wherein the control circuit
determines the number of the at least one first storage region into which data is to be written and a storage mode of the data for each of the at least one first storage region based on a size of the data to be written into the buffer region, and
writes the data into the at least one first storage region that is a write target in accordance with the determined storage mode.

7. The memory system according to claim 1, further comprising:
a management table that stores, for each of the first storage regions and each of the buffer storage regions, a number-of-bits information indicating the number of bits stored in each memory cell of the first memory cells and buffer memory cells, region information indicating either of the buffer region or the first storage region, and data storing information indicating that data is stored,
wherein the control circuit controls writing of the data into the first memory cells and the buffer memory cells based on the management table, and updates the management table after the data is written.

8. The memory system according to claim 1,
wherein each of the buffer region and the first storage region has a plurality of blocks, each of the plurality of blocks includes a corresponding predetermined number of the buffer storage regions and the first storage regions and is a data erase unit, and
wherein the control circuit manages the number of times of erasing data for each block, and, when the number of times of erasing on the block to which the at least one buffer region belongs exceeds a threshold value, allocates a free first storage region to the buffer region, and moves data in the buffer region belonging to the block on which the number of times of erasing exceeds the threshold value to the allocated free first storage region to the buffer region.

9. The memory system according to claim 1,
wherein each of the first memory cells and the buffer memory cells is a nonvolatile memory cell having a floating gate storing a logical value of data in accordance with an amount of injected electrons.

10. A memory control device for controlling writing of data into a memory, the memory includes a buffer region having a plurality of buffer storage regions, each buffer storage region including a plurality of buffer memory cells, the plurality of buffer memory cells being cells storing data of 1 bit or a plurality of bits in units of the buffer storage regions, and a first storage region having a plurality of first storage regions including the plurality of first memory cells storing data of a plurality of bits, the memory control device comprising:
a control circuit that
changes at least one buffer storage region in which data is written to at least one first storage region, and
changes at least one free first storage regions into at least one buffer storage region to replace the changed at least one buffer storage region.

11. The memory control device of claim 10, wherein
a number of the changed at least one buffer storage region and a number of the changed at least one free first storage region is the same when data of a plurality of bits is written in the buffer memory cells of the at least one changed buffer storage region.

12. The memory control device according to claim 10,
wherein the control circuit also
writes data into the buffer memory cells and the first memory cells in one of a single-bit mode in which 1-bit data is stored and a plurality of multi-bit modes in which the number of bits of storing data differs for each of the buffer storage regions such that a number of the buffer storage regions into which data is to be written is minimized.

13. The memory control device according to claim 10,
wherein control circuit
when changing the at least one buffer storage region to at least one first storage region, changes the at least one buffer storage region to the at least one first storage region such that data is written in a maximum multi-bit mode in which the number of bits of storing data is largest among the plurality of types of multi-bit modes, and
changes the at least one free first storage region to the at least one buffer storage region in a same number as the number of storage regions required for the data written in the maximum multi-bit mode to the buffer memory cells.

14. The memory control device according to claim 12,
wherein the control circuit moves data from a plurality of buffer storage regions to one of the first storage regions when data written in the plurality of buffer storage regions is in a mode other than the maximum multi-bit mode.

15. The memory control device according to claim 14,
wherein the control circuit
determines the number of the at least one first storage region into which data is to be written and a storage mode of the data for each of the at least one first storage region based on a size of the data to be written into the buffer region, and
writes the data into the at least one first storage region that is a write target in accordance with the determined storage mode.

16. The memory control device according to claim 10, further comprising:
a management table that stores, for each of the first storage regions and each of the buffer storage regions, a number-of-bits information indicating the number of bits stored in each memory cell of the first memory cells and buffer memory cells, region information indicating either of the buffer region or the first storage region, and data storing information indicating that data is stored,
wherein the control circuit controls writing of the data into the first memory cells and the buffer memory cells based on the management table, and updates the management table after the data is written.

17. The memory control device according to claim 10,
wherein each of the buffer region and the first storage region has a plurality of blocks, each of the plurality of blocks includes a corresponding predetermined number of the buffer storage regions and the first storage regions and is a data erase unit, and
wherein the control circuit manages the number of times of erasing data for each block, and, when the number of times of erasing on the block to which the at least one buffer region belongs exceeds a threshold value, allocates a free first storage region to the buffer region, and moves data in the buffer region belonging to the block on which the number of times of erasing exceeds the threshold value to the allocated free first storage region to the buffer region.

18. The memory control device according to claim 10,
wherein each of the first memory cells and the buffer memory cells is a nonvolatile memory cell having a floating gate storing a logical value of data in accordance with an amount of injected electrons.

19. A computer-implemented memory control method of controlling writing of data into a memory, the memory including a buffer region having a plurality of buffer storage regions, each buffer storage region including a plurality of buffer memory cells, the plurality of buffer memory cells being cells storing data of 1 bit or a plurality of bits in units of the buffer storage regions, and a first storage region having a plurality of first storage regions including the plurality of first memory cells storing data of a plurality of bits, the memory control method comprising:
changing, by a circuit, at least one buffer storage region in which data is written to at least one first storage region, and changing at least one free first storage region into at least one buffer storage region to replace the changed at least one buffer storage region.

20. The computer-implemented memory control method according to claim 19, wherein
a number of the changed at least one buffer storage region and a number of the changed at least one free first storage region is the same when data of a plurality of bits is written in the buffer memory cells of the at least one changed buffer storage region.
